(19) United States
(12) Patent Application Publication
(10) Pub. No.: US 2008/0248783 A1
(43) Pub. Date: Oct. 9, 2008

(54) METHOD AND APPARATUS TO FACILITATE SELECTING AN AUDIBLE ALERT THAT WILL CONTRAST WITH LOCAL AUDIBLE AMBIENT CONTENT

(75) Inventors: Ajoy Nandi, Pune (IN); Asma Farhin, Hawthorn Woods, IL (US); Farhan A. Siddique, Lake Zurich, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/695,993

(22) Filed: Apr. 3, 2007

(51) Int. Cl. H04Q 7/38

(52) U.S. Cl. 455/414.1

(57) ABSTRACT

A portable communications device (300) (upon determining (101) a need to alert a user of the device to a given event, such as, but not limited to, an incoming call) uses (103) information regarding local audible ambient content to select an audible alert having at least some sonic content (such as frequency content) that is intentionally different from and contrasting with sonic content as corresponds to the local audible ambient content to thereby provide a selected audible alert. This device then audibilizes (104) the selected audible alert to thereby alert the user regarding the given even through use of an audible alert that is likely to be heard and distinguished from the local audible ambient content.

### TECHNICAL FIELD

This invention relates generally to audible alerts as used by portable communication devices.

### BACKGROUND

Portable communication devices of various kinds are known in the art. These include both one-way reception devices as well as the relatively ubiquitous two-way platforms of various kinds and functionality. These include voice-only platforms, data-only platforms, and devices capable of handling both voice and data of various kinds. Being portable, such devices are often carried by their users to render them available when and as needed. When carried, however, the user's attention will typically be directed other than towards the portable communication device. As a result, such devices often employ audible alerts to notify the user of particular given events (such as, but not limited to, the existence of an incoming call).

Present practice often provides the user with a certain amount of flexibility regarding the volume of the audible alert and/or the particular audible alert that is audibilized with respect to a given event. For example, many such devices permit a user to assign a particular so-called ringtone for use when annunciating an incoming call.

While useful to a point, prior practice in this regard does not meet all needs. As one simple example in this regard, local audible ambient content can render, at any given moment, a particular pre-selected ringtone difficult to discern. This can happen, for example, when the sonic content of the ringtone matches, closely or exactly, with the sonic content of local ambient conditions. In such a case, the audible alert can be difficult to hear and otherwise distinguish from local conditions. Numerous other examples of mismatches between a device's audible alert settings and local audible ambient conditions at any given time exist as well. Such conditions can lead to missed calls and other unheeded circumstances that can lead to inconvenience or worse for the user.

### BRIEF DESCRIPTION OF THE DRAWINGS

The above needs are at least partially met through provision of the method and apparatus to facilitate selecting an audible alert that will contrast with local audible ambient content described in the following detailed description, particularly when studied in conjunction with the drawings, wherein:

FIG. 1 comprises a flow diagram as configured in accordance with various embodiments of the invention;

FIG. 2 comprises a table as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a portable communications device (upon determining a need to alert a user of the device to a given event, such as, but not limited to, an incoming call) uses information regarding local audible ambient content to select an audible alert having at least some frequency content that is intentionally different from and contrasting with frequency content as corresponds to the local audible ambient content to thereby provide a selected audible alert. This device then audibilizes the selected audible alert to thereby alert the user regarding the given even through use of an audible alert that is likely to be heard and distinguished from the local audible ambient content.

By one approach, if desired, the aforementioned information regarding the local audible ambient content can be locally developed. This can comprise, as one example, using a microphone as is also ordinarily used when receiving vocal input from the user of the portable communications device to sample local ambient conditions.

This information regarding local audible ambient content can comprise any of a wide variety of content. Examples include, but are not limited to, frequency information, wavelength information, period information, amplitude information, and/or velocity information as pertains to the locally audible ambient content.

The use of this information to select a contrasting audible alert can also contemplate any of a variety of approaches in this regard. For example, by one approach, this can comprise selecting an available candidate audible alert having the frequency content that is intentionally different from and contrasting with the frequency content as corresponds to the local audible ambient content. By another approach, in lieu of or in combination with the foregoing, this can comprise modifying an available candidate audible alert to have the frequency content that is intentionally different from and contrasting with the frequency content of the local audible ambient content.

These teachings will also readily accommodate selecting a particular audible alert based, in part, upon a particular corresponding amplitude, period, wavelength, velocity, or the like to thereby further distinguish the selected alert from local ambient conditions.

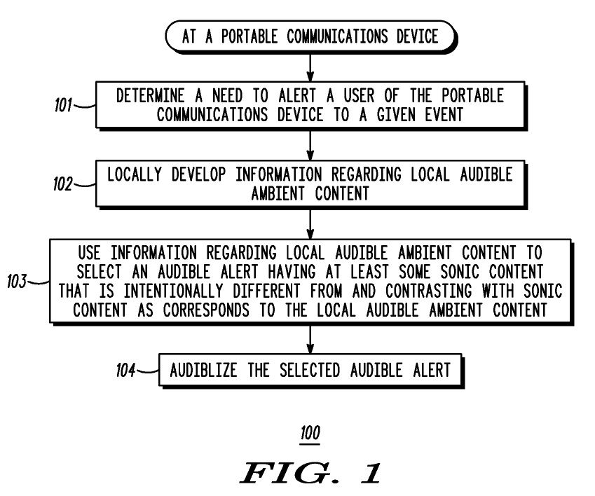

These and other benefits may become clearer upon making a thorough review and study of the following detailed description. Referring now to the drawings, and in particular to FIG. 1, a description of various processes 100 as may be carried out by a portable communications device will be described.

By the illustrated approach, a portable communications device determines 101 a need to alert a user of the portable communications device to a given event. For the purposes of illustration and not by way of limitation, this given event may comprise an incoming call. By one approach this can comprise detecting a confirmed incoming call state. If desired, however, this can also comprise detecting indicia of a likely incoming call. The latter may be possible, for example, when the signaling protocol as used with the portable communications device features some preliminary messaging that may, or may not, ultimately lead to a confirmed incoming call state. For example, the personal communications device may use a system page as a triggering event in this regard.

At least one benefit of detecting the likely early stages of a given event is to provide additional time for other actions contemplated herein to be undertaken. This, in turn, can assist with more timely selection and use of a useful audible alert. As the present teachings are not overly sensitive to the selection of any particular approach in these regards, for the sake of brevity and the preservation of clarity additional elaboration in this regard will not be provided here.

By one optional approach, if desired, these teachings will accommodate locally developing 102 information regarding local audible ambient content. By one approach this can comprise, in whole or in part, the use of a microphone by which the local audible ambient content can be sampled. If desired, this microphone can be one that is also ordinarily used when received vocal input from the user of the portable communications device. It would also be possible, of course, to use a separate microphone for such a purpose. Other possibilities exist as well. For example, the portable communications device could include a plurality of microphones to be used, at least in part, for this purpose. By this approach, for example, a stereo microphone arrangement could serve to provide additional corresponding information regarding the local audible ambient content.

By one approach, this local development of such information can begin in response to determining the aforementioned need to alert the user to a given event. By another approach, if desired, such information might be developed from time to time regardless of having determined such a need in order to have such information available in immediately usable or readily updatable form when needed. It would also be possible, if desired, to capture and to process such information on a more or less substantially continuous basis (during, for example, normal operational states).

The amount and/or kind of information so developed can vary with respect to the requirements of a given application setting. In general, for many purposes, a relatively short sample of local audible ambient content will often suffice for the present purposes. The information so developed can pertain to a variety of characterizing aspects as desired. Examples in this regard include, but are not limited to, frequency information as pertains to the locally audible ambient content, wavelength information as pertains to the locally audible ambient content, period information as pertains to the local audible ambient content, amplitude information as pertains to the locally audible ambient content, and/or velocity information as pertains to the locally audible ambient content.

By one approach, if desired, such information can then be used to classify the local audible ambient content into a particular category. Potentially useful candidate sound environments might include, but are certainly not limited to, stadium settings, train settings, musical backgrounds, dance club settings, background conversations, bus settings, restaurant settings, airport settings, urban street settings, and so forth. Various sound recognition tools (based, for example, upon use of corresponding probabilistic models) are known in the art to support such classification and require no further elaboration here.

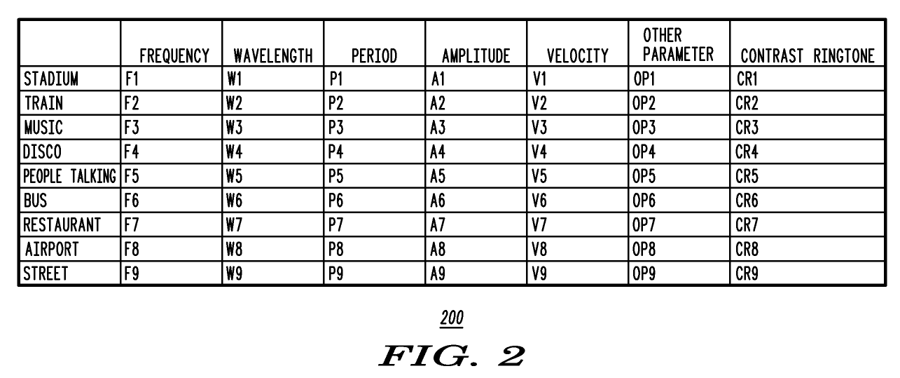

Regardless of how developed, these teachings then provide for using 103 that information regarding local audible ambient content to select an audible alert having at least some sonic content (such as frequency content) that is intentionally different from and contrasting with sonic content as corresponds to the local audible ambient content to thereby provide a selected audible alert. By one approach, such as that suggested by FIG. 2, this can comprise using the identified sound environment with a table 200 to identify a particular contrasting ringtone. To illustrate, as shown, a ringtone denoted as CR5 can be selected for use when the local audible ambient content is categorizable as comprising, at least for the most part, people engaged in conversations.

Accordingly, this step of selecting a contrasting audible alert can comprise selecting an available candidate audible alert that has at least some frequency content that is intentionally different from and that contrasts with the frequency content as corresponds to the local audible ambient content. These teachings will also accommodate, however, in lieu of this approach or in combination therewith, modifying an available candidate audible alert to have the frequency content that is intentionally different from and that contrasts with the frequency content of the local audible ambient content.

Those skilled in the art will understand and appreciate that selecting an audible alert having contrasting frequency content will assist greatly with respect to differentiating the audible alert from the user's present audio background conditions. It will also be understood, however, that additional aspects of the audible alert can be modified as well in these regards. The amplitude of the audible alert, for example, can also be selectively manipulated to suit local conditions. This could comprise as appropriate increasing the volume of the audible alert to better ensure that the user will hear the alert. This could also comprise, however, setting the volume of the audible alert at a relatively low level when possible to thereby avoid unnecessarily disturbing others in the vicinity of the user. Numerous other possibilities exist in this regard as well as will be well understood by one skilled in the art.

This process 100 will then accommodate audibilizing 104 the selected audible alert to thereby alert the user regarding the given event through use of an audible alert that is likely to be heard and distinguished from the local audible ambient content. In particular, as per these teachings, at least some of the frequency content of the selected audible alert is likely to be sufficiently distinct and contrasting with the frequency content of the local audible ambient content as to avoid sonically masking the audible alert.

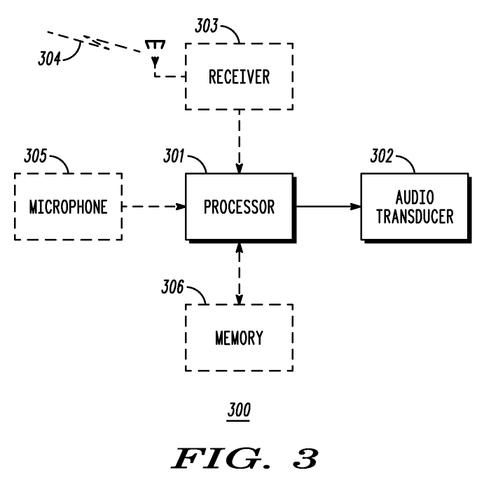

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

The personal communications device 300 shown can comprise essentially any such device having virtually any form factor and/or additional functionality of choice. Present examples would include, but are not limited to, cellular telephones, push-to-talk platforms, voice-only platforms, non-voice data-only platforms, and so forth.

In this illustrative embodiment the personal communications device 300 comprises a processor 301 that operably couples to an audio transducer 302 that is configured and arranged to selectively render an audible alert audible. That latter can comprise, for example, an audio amplifier and speaker. The processor 301 itself can be configured and arranged (via, for example, corresponding programming as will be well understood by those skilled in the art) to carry out some or all of the actions and steps set forth herein. This can include, for example, determining the aforementioned need to alert the user of the device 300 of a given event, using information regarding local audible ambient content to select an appropriate audible alert, and causing provision of that selected audible alert to the audio transducer 302.

Depending upon the needs and/or opportunities of a given application setting, this portable communications device 300 can also comprise a wireless receiver 303 that is operably coupled to the processor 301 and that serves to receive, for example, an incoming call 304 that can comprise the aforementioned given event that requires a corresponding audible alert. A microphone 305 that operably couples to the processor 301 can serve to facilitate the aforementioned development of information regarding local audible ambient content. And, as appropriate or desired, a memory 306 that operably couples to the processor 301 can contain categorizing information, candidate audible alerts, and so forth as useful or necessary to facilitating the provision of a suitably contrasting audible alert as per these teachings.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize and appreciate that these teachings can be implemented in a highly cost effective manner if desired. By one approach, for example, these teachings are readily implemented in a manner that makes significant re-use of a given device's existing native functionality and hence serves to highly leverage already existing capabilities for the described purposes.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a portable communications device:
determining a need to alert a user of the portable communications device to a given event;
using information regarding local audible ambient content to select an audible alert having at least some frequency content that is intentionally different from and contrasting with frequency content as corresponds to the local audible ambient content to provide a selected audible alert;
audibilizing the selected audible alert to thereby alert the user regarding the given event through use of an audible alert that is likely to be heard and distinguished from the local audible ambient content.

2. The method of claim 1 wherein the given event comprises an incoming call.

3. The method of claim 1 further comprising:
locally developing the information regarding local audible ambient content to thereby provide the information.

4. The method of claim 3 wherein locally developing the information comprises, at least in part, using a microphone as is also ordinarily used when receiving vocal input from the user of the portable communications device.

5. The method of claim 3 wherein locally developing the information comprises, at least in part, initiating locally developing the information in response to detecting at least an increased likelihood of the given event occurring.

6. The method of claim 1 wherein the information comprises, at least in part, at least one of:
frequency information as pertains to the locally audible ambient content;
wavelength information as pertains to the locally audible ambient content;
period information as pertains to the locally audible ambient content;
amplitude information as pertains to the locally audible ambient content;
velocity information as pertains to the locally audible ambient content.

7. The method of claim 1 wherein using information regarding local audible ambient content to select an audible alert comprises, at least in part, classifying the local audible ambient content as being one of a number of available candidate sound environments.

8. The method of claim 1 wherein using information regarding local audible ambient content to select an audible alert having at least some frequency content that is intentionally different from and contrasting with frequency content as corresponds to the local audible ambient content to provide a selected audible alert comprises, at least in part, at least one of:
selecting an available candidate audible alert having the frequency content that is intentionally different from and contrasting with frequency content as corresponds to the local audible ambient content;
modifying an available candidate audible alert to have the frequency content that is intentionally different from and contrasting with frequency content as corresponds to the local audible ambient content.

9. The method of claim 1 wherein the given event comprises a system page that may indicate the existence of an incoming call.

10. An apparatus comprising a portable communications device comprising:
an audio transducer configured and arranged to selectively render an audible alert audible;
a processor operably coupled to the audio transducer and being configured and arranged to:
determine a need to alert a user of the portable communications device to a given event;
use information regarding local audible ambient content to select an audible alert having at least some frequency content that is intentionally different from and contrasting with frequency content as corresponds to the local audible ambient content to provide a selected audible alert;
cause provision of the selected audible alert to the audio transducer to thereby alert the user regarding the given event through use of an audible alert that is likely to be heard and distinguished from the local audible ambient content.

11. The apparatus of claim 10 wherein the given event comprises an incoming call.

12. The apparatus of claim 10 wherein the processor is further configured and arranged to locally develop the information regarding local audible ambient content to thereby provide the information.

13. The apparatus of claim 12 further comprising a microphone that is ordinarily used when receiving vocal input from the user of the portable communications device and wherein the processor is configured and arranged to locally develop the information by, at least in part, using the microphone.

14. The apparatus of claim 12 wherein the processor is further configured and arranged to locally develop the information by, at least in part, initiating locally developing the information in response to detecting at least an increased likelihood of the given event occurring.

15. The apparatus of claim 10 wherein the information comprises, at least in part, at least one of:
frequency information as pertains to the locally audible ambient content;
wavelength information as pertains to the locally audible ambient content;
period information as pertains to the locally audible ambient content;
amplitude information as pertains to the locally audible ambient content;
velocity information as pertains to the locally audible ambient content.

16. The apparatus of claim 10 wherein the processor is further configured and arranged to use information regarding local audible ambient content to select an audible alert by, at least in part, classifying the local audible ambient content as being one of a number of available candidate sound environments.

17. The apparatus of claim 10 wherein the processor is further configured and arranged to use information regarding local audible ambient content to select an audible alert having at least some frequency content that is intentionally different from and contrasting with frequency content as corresponds to the local audible ambient content to provide a selected audible alert by, at least in part, at least one of:
selecting an available candidate audible alert having the frequency content that is intentionally different from and contrasting with frequency content as corresponds to the local audible ambient content;
modifying an available candidate audible alert to have the frequency content that is intentionally different from and contrasting with frequency content as corresponds to the local audible ambient content.

18. The apparatus of claim 10 wherein the processor comprises, at least in part, means for:
determining a need to alert a user of the portable communications device to a given event;
using information regarding local audible ambient content to select an audible alert having at least some frequency content that is intentionally different from and contrasting with frequency content as corresponds to the local audible ambient content to provide a selected audible alert;
causing provision of the selected audible alert to the audio transducer to thereby alert the user regarding the given event through use of an audible alert that is likely to be heard and distinguished from the local audible ambient content.

19. The apparatus of claim 10 wherein the given event comprises a system page that may indicate the existence of an incoming call.
